(19) United States
(12) Patent Application Publication
(10) Pub. No.: US 2008/0003322 A1
(43) Pub. Date: Jan. 3, 2008

(54) VACUUM, WRAP, AND TRIM SYSTEM FOR THE MANUFACTURER OF COMPONENTS

(75) Inventor: Randy S. Reed, Fair Haven, MI (US)

Correspondence Address: Dickinson Wright PLLC, 38525 Woodward Avenue, Suite 2000, Bloomfield Hills, MI, 48304, US

(73) Assignee: LEAR CORPORATION, Southfield, MI (US)

(21) Appl. No.: 11/419,530

(22) Filed: May 22, 2006

(51) Int. Cl. B29C 39/42

(52) U.S. Cl. 425/388; 425/DIG. 6; 425/383

(57) ABSTRACT

A vacuum-forming system (10) for manufacture of a component includes a vacuum-forming mold (18, 20). The vacuum-forming mold (18, 20) may be heated. One or more wrapping arms (60, 62, 64) are in operative coupling with the vacuum-forming mold (18, 20). One or more cutting elements (196, 207, 262) are mechanically coupled to the vacuum-forming mold (18, 20), the wrapping arms (60, 62, 64), or a substrate (40). A controller (42) may be coupled to and adjust the temperature of the cutting elements (196, 207, 262). A controller (42) may also or as an alternative be coupled to and control the operation of the wrapping arms (60, 62, 64) to wrap a compliant cover stock object (22) on the substrate (40) and to simultaneously trim the object (22) via the cutting elements (196, 207, 262).

### TECHNICAL FIELD

This invention is related to manufacturing systems and methods for vehicle interior components, such as interior panels, covers, dashboards, consoles, and the like. More particularly, the present invention is related to an improved vacuum-forming technique for the manufacture of such components.

### BACKGROUND OF THE INVENTION

Vacuum-forming is commonly utilized in the art for the manufacture of vehicle interior three-dimensional components. The components typically include a substrate layer and a thermo formable sheet cover stock that is adhered thereon. The cover stock is heated and formed onto the substrate to form a component.

Previously to produce the component many stages were utilized and required. Three of the stages included vacuum-forming, wrapping, and trimming. During vacuum-forming the cover stock is in the form of a precut sheet that is shaped into a predetermined configuration to form a “skin”, which is adhered to the front side of the substrate. During wrapping a peripheral part of the cover stock is folded over an edge of the substrate and adhered to the backside of the substrate. During trimming, unnecessary portions of the cover stock is cut off, removed, and discarded. Conventionally the stated stages and others have been carried out in a successive manner using multiple devices and systems, such as punch machines, post edge wrap machines, and sonic welding machines, each of which designated and associated with a particular stage.

One known system performs vacuum-forming, wrapping, and trimming in a single stage. The system includes a wrapping and trimming arm that is positioned proximate the vacuum-forming mold, such that during the later end of the vacuum- forming process the arm- is used to wrap and trim the cover stock. The arm unidirectionaily pushes against, and causes the peripheral portion of the cover stock to wrap over the backside of the substrate. The arm has a trimming edge or blade that cuts the cover stock upon wrapping via pressure and heat applied on the cover stock.

Although the above-described system reduces the number of stages involved in the manufacturing process, it is limited in use and to less complex-shaped components. The described system does not account for and assure a proper adhering of the cover stock to the backside and edge of the substrate. Also, the stated system does not account for multi-directional wrapping and trimming on multiple edges and corners of a substrate. In addition, the system requires that a cutting element be used on a separately actuated cutting tool.

### SUMMARY OF THE INVENTION

The embodiments of the present invention provide several advantages. In one embodiment of the present invention, a vacuum-forming system for manufacture of a component is provided that includes a vacuum-forming mold. A wrapping arm is in operative coupling with the vacuum-forming mold. A cutting element is mechanically coupled to the wrap ping arm, A controller adjusts the tempera lure of the .cutting element. An advantage associated with the stated embodiment is the ability to use the heated cutting elements during the vacuum-forming of a compliant cover stock object onto a substrate. The heated cutting elements assure a proper cut of the object and aid in the bonding of the object to the substrate.

In another embodiment, a vacuum-forming system for manufacture of a component is provided that likewise includes a vacuum-forming mold and a wrapping arm that is in operative coupling with the vacuum-forming mold. A cutting element, such as a component-based cutting element and/or a mold-mounted cutting element, is coupled to the wrapping arm. A controller controls the operation of the wrapping arm to wrap a compliant cover stock object on a substrate and to simultaneously trim the object via the cutting element. Another advantage, which is provided by the above- stated embodiment, is the use of a component-base cutting element and/or a mold- mounted cutting element, which increase vacuum-forming system versatility. This allows for increased vacuum-forming hardware and manufactured component configurations for various applications.

In yet another embodiment, a vacuum-forming system for manufacture of a component is provided that includes a vacuum-forming mold. The mold is configured for vacuum-forming a compliant cover stock object onto a substrate of the component. Wrapping arms are in operative coupling with the vacuum-forming mold and wrap peripheral edges of the object on a substrate of the component simultaneously with the vacuum-forming. A controller controls the wrapping operation. Yet another advantage provided by and associated with the above-stated embodiment, is the ability to form, wrap, tuck, and trim a manufactured component in a 360°format during a single vacuum-forming stage. This eliminates the need for punch machines, post edge wrapping machines, sonic welding machines for welding a skin to a substrate, and other devices commonly associated with conventional multi-stage vacuum-forming processes.

Still another advantage provided by another embodiment of the present invention is that of heated vacuum-forming mold portions. This allows a cover stock to flow, stretch, and thus form better and more uniformly on and over a substrate.

As well, another advantage provided by an embodiment of the present invention is the incorporation of a single stage vacuum-forming system that forms, wraps, tucks, and trims edges and inner holes of cutouts of a cover stock object and also bonds the cover stock to a substrate.

The above-stated embodiments also minimize the number and size of the tools utilized within a component manufacturing process, the time to manufacture a component, and the amount of non-used excess skin material. The above-stated embodiments also increase the grain retention time of the component

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a block diagrammatic view of a vacuum-forming system in accordance with an embodiment of the present invention;

FIG. 2 is a side view of an upper vacuum-forming mold system in accordance with an embodiment of the present invention;

FIG. 3 is a front view of the upper vacuum-forming mold system of FIG. 2;

FIG. 4 is a close-up perspective corner view of the upper vacuum- forming mold system of FIG. 2;

FIG. 5 is a front perspective corner view of the upper vacuum-forming mold system of FIG. 2;

FIG. 6 is a side view of a wrapping, tucking, and trimming mechanism in accordance with an embodiment of the present invention;

FIG. 7 is a side view of a wrapping and tucking mechanism in accordance with another embodiment of the present invention;

FIG. 8 is a front perspective view of a belt line return flange in accordance with an embodiment of the present invention;

FIG. 9 is an upper side perspective view of the belt line return flange of FIG. 8;

FIG. 10 is a bottom view of a corner of a substrate incorporating a corner cutting element in accordance with an embodiment of the present invention;

FIG. 11 is a perspective view of a lower mold of a vacuum-forming systern in accordance with another embodiment of the present invention;

FIG. 12 is a close-up front sectional view of a substrate mount in accordance with an embodiment of the present invention;

FIG. 13 is a perspective view of a sample trim detail in accordance with an embodiment of the present invention; and

FIG. 14 is a logic flow diagram illustrating a method of manufacturing a component in accordance with an embodiment of the present invention.

### DETAILED DESCRIPTION

In each of the following figures, the same reference numerals are used to refer to the same components. While the present invention is described, primarily with respect to the manufacture of interior vehicle components, the present invention may be adapted to various interior and non-interior vehicle applications, as well as to non-vehicle applications. The present invention may be used in headliner applications, interior sidewall panel applications, pillar applications, console panel applications, dashboard applications, rear trim panel applications, door panel applications, and other interior trim applications. The present invention may apply to automotive, aeronautical, nautical, and railway industries, as well as to other industries that utilize vacuum-forming processes.

In the following description, various operating parameters and components are described for one constructed embodiment. These specific parameters and components are included as examples and are not meant to be limiting.

Also, in the following description the term “stage” or “single stage” of a process refers to the one or more tasks performed at a single station. For example, the present invention allows for the tasks of wrapping, tucking, and trimming, as well as other tasks to be performed at a single station and with a single set of tools. Conventional systems required multiple stages to perform similar tasks.

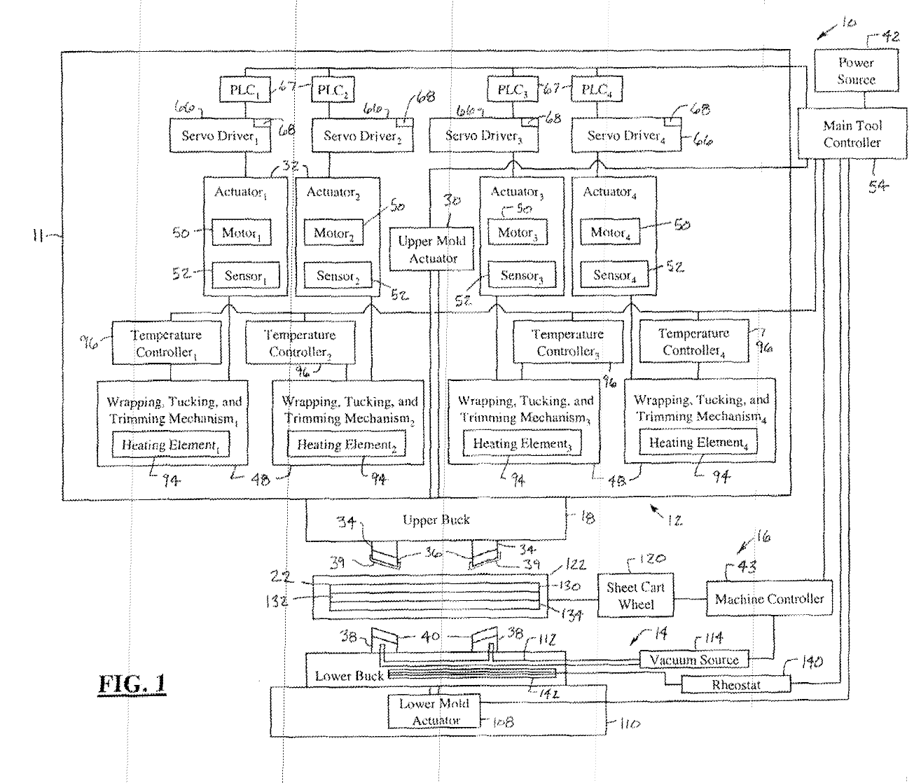

Referring now to FIG. 1, a block diagrammatic view of a vacuum-forming system 10 in accordance with an embodiment of the present invention is shown. The vacuum-forming system 10 includes a tool 11, with an upper mold vacuum-forming system 12 and a lower mold vacuum-forming system 14, and a stock transport system 16. The upper mold system 12 includes an upper buck 18, which may be referred to as an upper mold., an upper platen, or an upper lid. The lower mold system 14 includes a lower buck 20, which may be referred to as a lower mold, a lower platen, or a lower lid. The upper mold 18 and the lower mold 20 in combination may be referred to as the vacuum-forming mold. During the vacuum-forming process the stock transport system 16 inserts a heated cover stock material, referred to as a compliant cover stock object 22, between the upper mold 18 and the lower mold 20. The upper mold 18 and the lower mold 20 may have guide pins and adjustable stops (not shown) thereon and are held in a parallel format. The upper mold 18 and the lower mold 20 may be approximately the same weight. The vacuum-forming system 10, in a single stage, forms, wraps, tucks, bonds, and trims the cover stock material onto and over one or more substrates 40 (two substrates are shown) located on the lower mold 20.

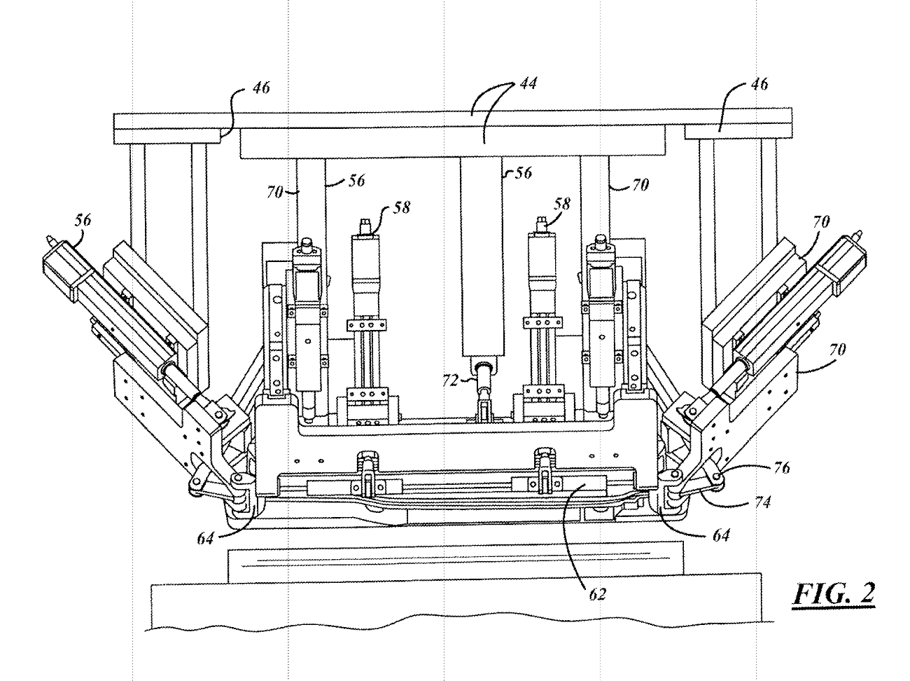

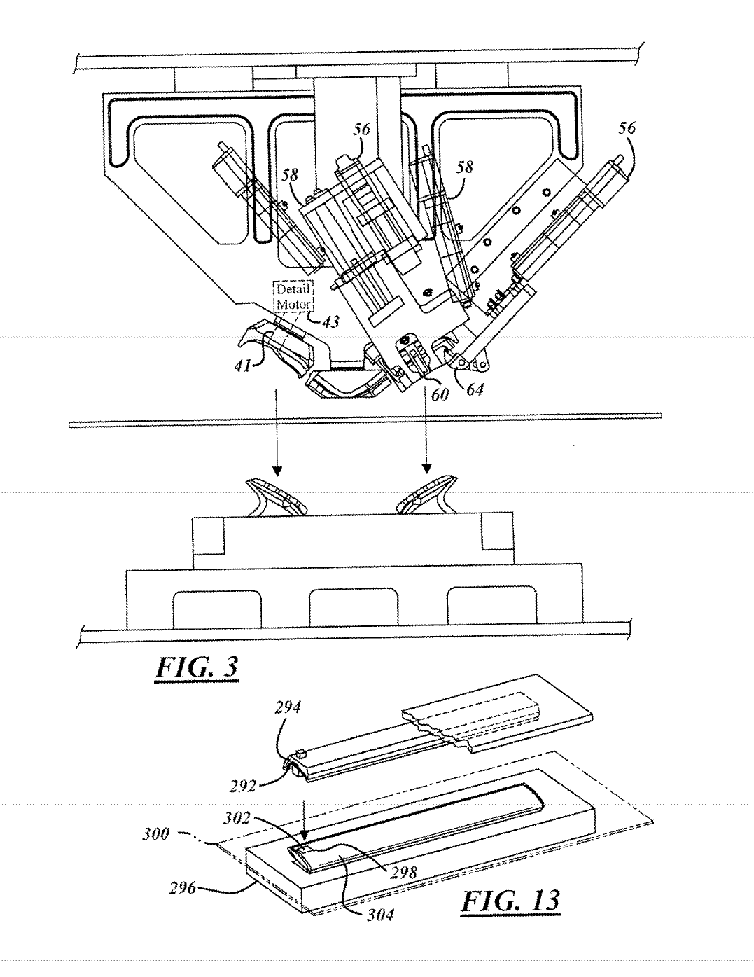

Referring now also to FIGS. 2-3, a side view and a front view of the upper mold system 12 are shown. The upper mold system 12 includes the upper mold 18, the upper mold actuator 30, and multiple wrapping, tucking, and trimming actuators 32. The upper mold 18 may be formed of aluminum or some other suitable material. The upper mold 18 has forming mounts 34, which are in the form of billets, attached thereon. The forming mounts 34 may be formed of steel, aluminum, or other supporting materials that are able to withstand the temperatures experienced in a vacuum-forming environment.

Nests 36 are attached to the forming mounts 34 and correspond and have similar shape as the substrate mounts 38 on the lower mold 20. The nests 36 may include trim details and mechanisms (not shown in FIGS. 1-3), some of which are described below. The nests 36 may be formed of cast urethane. The nests 36 are held on to the forming mounts 34 via a series of holes (not shown) in the forming mounts 34 and a chemical bond between the forming mounts and the nests 36. The material of the nests is heated, such that it flows in and out of the holes in the forming mounts 34 and then is cooled. This process bonds and attaches the forming mounts 34 to the nests 36. Of course, any other technique known in the art for attaching the forming mounts 34 to the nests 36 may be utilized. The nests 36 may be referred to as upper plugs or as plug assists and may have extensions (not shown) formed of epoxy or other suitable material. The nests 36 may be covered with a mole skin 39 or the like. “Mole skin” refers to a soft pressure-sensitive adhesive (PSA) cloth that covers the nests and is capable of withstanding heat and pressure. The mole skin 39 allows the nests 36 to come in contact with and not mark up the cover stock material. The nests 36 help to pre-shape the cover stock material without marking the material and allow other details to be mounted to the upper mold 18, such as trim blades. The nests 36 also hold the cover stock material and the substrates 40 from moving during the trimming process.

In one embodiment, the nests include a trim details 41 (only one is shown) that are in the form of pistons that are actuated by detail motors 43 (only one is shown). The trim details 41 are displaced through the nests 36 and through the formed cover stock material to punch a hole therein. The detail motors may be coupled to a main tool controller 42 and be electrical, hydraulic, or pneumatic in form. The trim details may be in a fixed location on the nests or may be position adjustable and/or actuabJe. The trim details 41 may have cutting edges formed therein or attached thereon. Another example of a trim detail is shown and described with respect to FIG. 13.

The upper mold actuator 30 is mechanically coupled to and is used to displace the upper mold 18 towards the lower mold 20. The upper mold actuator 30 is electrically coupled to and is controlled by the main controller 42 and by the machine controller 43. The wrapping, tucking, and trimming actuators 32 are supported by-support plates 44 and mounts 46, are mechanically attached to the upper mold 18, and are used to manipulate the wrapping, tucking, and trimming mechanisms 48 to wrap, tuck, and trim peripheral portions of the compliant cover stock object 22 on and over the substrates 40.

Each of the wrapping, tucking, and trimming actuators 32 includes one or more motors 50 and one or more sensors 52 (only one of each is shown). The actuators 32 are linked to an external controller, such as the main controller 42, which is powered by a power source 54. The actuators 32 may be in the form of robotic electro/mechanical ball screw cylinders, which are computer or logic device drive, or may be in some other form known in the art. The actuators 32 may be hydraulic, pneumatic, pneudraulic, mechanical, and/or electrically driven. Although in FIG. 1 a single actuator is shown as being associated with each wrapping, tucking, and trimming mechanism 48, any number of actuators may be utilized. In one embodiment, each wrapping, tucking, and trimming mechanism 48 has two actuators associated therewith. An example of such an embodiments shown and described with respect to FIGS. 2-3. For example, in FIGS. 2-3 deploying/retracting actuators 56 and curing actuators 58 are shown for the end curling arms 60 (only one is shown), the belt line curling arms 62 (only one is shown), and the corner curling arms 64.

The motors 50 and the sensors 52 are coupled to respective servo drivers 66, which in turn are controlled by programmable logic circuits (PLCs) 67. The servo drivers 66 include programmable cards 68 for controlling the position and braking of the actuators 32. The motors 50 are used to position and brake components, such as arms, linkages, billets, bail screws, tuck and trim bars, and other various components. The servo drivers 66 may have various inputs and outputs, such as that associated with position control, brake control, rate control, homing, alarms, actuator motor control, actuator sensor signals, etc. The servo drivers 66 may be programmed to perform a single movement, a double movement, an extension, a retraction, or other known movements. The servo drivers 66 and the actuators 32 tend to work in pairs whereby, for example, a first servo driver and actuator combination may linearly drive a tuck and trim bar to an initial position adjacent a substrate, while another servo driver and actuator combination may curl the tuck and trim bar to tuck and cut cover stock material. The curling may be performed using a cam mechanism. The actuators 32 and motors 50 due to their physical makeup and electronic associated controls are repeatable and accurate. The sensors 52 may be in the form of position sensors, encoders, infrared sensors, linear transducers, rotary sensors, or other sensor types that may be used to detect the position and orientation of the components of the wrapping, tucking, and trimming mechanisms 48.

The PLCs 67 program the cards 68 and may be of various types and styles known in the art. The PLCs 67 may be programmed via the main controller 42, a laptop computer (not shown), via a handheld teach pendent (not shown), or via some other programming device known in the art. The PLCs 67 may be programmed individually or simultaneously. Manual control of the actuators 32 may also be obtained through the PLCs 67 for testing or setup purposes.

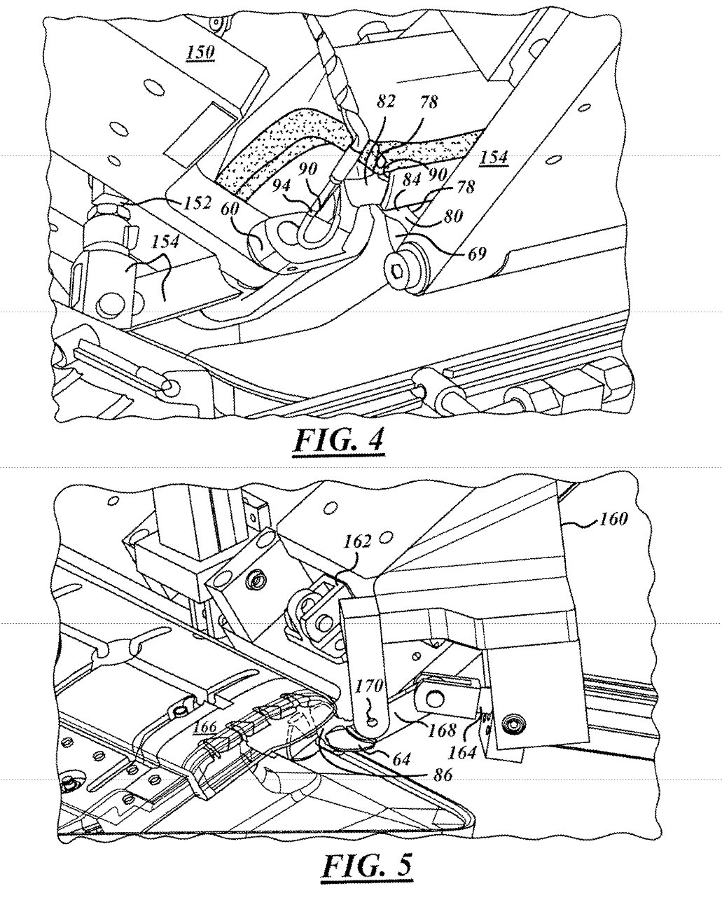

The wrapping, tucking, and trimming mechanisms 48 provide 360° of wrapping, tucking, and trimming ability around the two substrates 40, as associated with the embodiments of FIGS. 1 and 3, or around a single substrate. The wrapping, tucking, and trimming mechanisms 48 are driven by the actuators 32, which are attached to billets 70. Actuated rods 72 of the actuators 32 are attached to the curling arms 60, 62, and 64 via linkages 74 and associated pivot pins 76. The tuck and trim bars 78, which are best seen in FIGS. 4 and 7-8, are attached to the ends 80 of the curling arms 60, 62, and 64. The tuck and trim bars 78 may be integrally formed as part of or as a single unit with the curling arms 60, 62, and 64. Several different types of tuck and trim bars may be utilized, which include end (front and back) tuck and trim bars 82, side tuck and trim bars (not shown), belt line tuck and trim bars 84, and corner tuck and trim bars 86. Examples of each are shown in FIGS. 4-7.

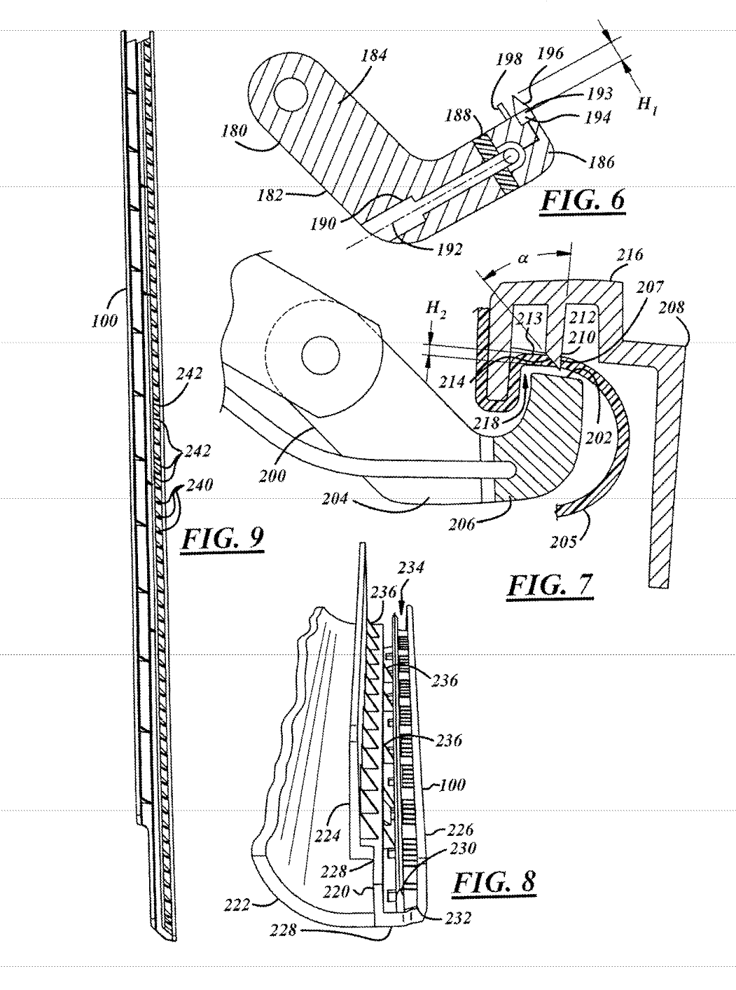

The tuck and trim bars 82, 84, and 86 may be formed of copper, bronze, steel, ceramic, iron, titanium, or other material or combination thereof which is capable of withstanding melting temperatures of the cover stock object 22; such temperatures may exceed 300° F. The tuck and trim bars 82, 84, and 86 may be machined to tuck cover stock material on various different substrate surfaces. The curling arms 60, 62, and 64 have a curved and cup-shaped cross-section, which allows them to curl inward the tuck and trim bars 82, 84, and 86 and push the peripheral edges of the cover stock on, over, and around ends of the substrate 40. The curling arms 60, 62, and 64 also curl the tuck and trim bars to tuck a portion of the peripheral edges under and onto backsides or under sides 90 of the substrates 40. The tuck and trim bars 82, 84, and 86 may have cutting elements, such as that shown in FIG. 6, or smooth surfaced tucking ends, such as that shown in FIG. 7.

Both the cutting elements and the tucking ends may have heating elements (only one is shown) 94 that are attached thereto, incorporated therein, or formed as an integral part thereof, as shown in FIG. 4, The heating elements 94 are electrically coupled to temperature controllers 96, which in turn are coupled to the main controller 42. The temperature controllers 96 maintain even-and uniform temperatures between the tuck and trim bars 82, 84, and 86 to compensate for mass and size differences thereof. In one embodiment the tuck and trim bars 82, 84, and 86 are maintained at a temperature of approximately 128° F.±7° F.

The heating elements 94 are used to increase the temperature of tucked portions of the cover stock object 22 to aid in the cutting of the object 22 and in the bonding of the object 22 to the substrates 40 or to a flange attached thereto. For example, in the embodiments associated with FIGS. 8-10, a belt return flange 100 and a corner flange 102 are attached to a substrate. Such flanges may be attached to or integrally formed as part of the substrates 40. The cover stock object 22 may also be bonded to such flanges during the vacuum-forming process. The heating elements 94 may be in the form of film heaters, cable heaters, flexible heaters, tubular heaters, or some other form of heating elements. Examples of the stated heating elements, which may be used, are Waltlow™ heaters by Wallow Electric Manufacturing Company of St. Louis, Missouri.

The main controller 42 and the machine controller 43 may be microprocessor based such as a computer having a central processing unit, memory (RAM and/or ROM), and associated input and output buses. The main controller 42 and the machine controller 43 may be an application-specific integrated circuit or may be formed of other logic devices known in the art. The main controller 42 and the machine controller 43 may be a portion of a central main control unit a “smart” brain, a main control panel, a control circuit having a power supply, or may be a stand-alone controller as showm. The main controller 42 receives power from the power source 54 and controls how power is distributed to the devices of the upper mold system 12 and the lower mold system 14. The machine controller 43 also receives power from the power source 54 and controls how power is distributed to the stock transport system 16. The main controller 42 is used primary to control the tool 11 and the devices thereon, whereas the machine controller 43 is primarily used to control the opening and closing of the molds 18 and 20, a vacuum source 114, a sheet cart, shuttle, or in-line machine wheel 120, and an index clamp frame 122. The controllers 42 and 43 may be combined into a single controller and are in constant communication with each other.

The actuators 32, the servo drives 66, the PLCs 67, and/or the main controller 42 may have fail safe logic that assures that the curling arms 60, 62, and 64 are retracted prior to opening or separating of the upper mold 18 and the lower mold 20 upon vacuum-forming. Position sensors, limit switches, or other sensors (not shown) may be utilized to detect or indicate that the upper mold 18 and the lower mold 20 are or are about to move apart from each other.

The upper mold 18 may also include other trimming details, such as punches, vacuum cups, vacuum elements, steel rule trim dies, movable/actuated trim slides, and other known trimming details. An example of a punch is shown in FIG. 13.

The lower mold system 14 includes the lower mold 20, which is displaced via the lower mold actuator 108 and is located over a table 110. The lower mold 20 may be formed of aluminum or some other suitable material. The lower mold actuator 108 is coupled to the main controller 42. The lower mold 20 contains vacuum channels 112 that extend into the substrate mounts 38. The vacuum channels 112 are in communication with the vacuum source 114. The controller 42 activates the vacuum source 114 to attract the cover stock object 22 to the substrates 40. The vacuum source 114 may also be used to attract the substrates 40 to the substrate mounts 38. The lower mold system 14 may include mechanical locking features (not shown) for locking the substrates 40 in place.

The stock transport system 16 includes the wheel 120 that is used to transport the cover stock object 22 between an oven and the molds 18 and 20. The cover stock material is held by the index clamp frame 122, which is positioned between the molds 18 and 20. The index clamp frame 122 is used to aid in the wrapping process. The clamp frame 122 moves material in towards the lower mold 20 as the lower mold 20 is moving towards the upper mold 18 and to its extended position. This may also occur as the vacuum source 114 is activated to generate a low-pressure environment between the cover stock object 22 and the substrates 40.

The cover stock object 22 may have multiple layers of various densities and thicknesses. The cover stock object 22 may have an outer layer 130 and a backing layer 132. The outer layer 130 and the backing layer 132 may be formed of various materials, such as a thermoplastic elastomer (TPE), recyclable thermoplastic polyolefin (TPO), thermoplastic polyurethane (TPU), polypropylene, foam, vinyl, polyvinyl chloride (PVC), unsupported expanded vinyl (UEV), polyurethane (PUR), acrylonitrile butadiene styrene (ABS), or other vacuum formable material or a combination thereof. An adhesive and/or an adhesive layer 134 may be attached, sprayed on, or applied to the backing layer 132. The adhesive layer 134 may be pre-applied to the cover stock object. The adhesive layer 134 may be solvent based, 1k and 2k water born, or able to be melted to form an adhesive film. Note that an adhesive and/or an adhesive layer (not shown) may also be applied to the substrates 40. When the adhesive layers are sprayed on, components may be masked off. The cover stock object 22 and the substrates 40 may be masked off to prevent adhesive from being applied in undesired areas, which prevents the bonding of cover stock material to the substrate in inappropriate areas during vacuum-forming.

The vacuum-forming system 10 also includes a mold heating system 140 for heated selected portions of the lower mold 20. The mold heating system 140 includes mold heating elements 142 that extend within one or more of the molds 18 and 20 (heating elements are only shown within the lower mold 20). The heating elements may be in various configurations and arrangements on and within the lower mold 20. The heating elements 142 may be in the form of tubular heating rods, sometimes referred to as cal-rods that are electrically activated. The heating elements 142 may also, or as an alternative, be in the form of fluid circulating elements, in which a heated fluid is circulated therethrough. The tubular heating rods are attached to a rheostat 144 and/or to the main controller 42. The rheostat 144 may be in the form of a voltage or current regulator. The use of the tubular heating rods allows for heating of one or more of the molds 18 and 20 for improved stretching and forming of the cover stock object 22. As an alternative, the heating elements 142 may be in the form of channels that form a heating fluid circuit in which heated fluid passes therethrough. When fluidic channels are incorporated, the fluid may be heated via a heater (not shown), which also may be coupled to and controlled by the main controller 42.

Referring now to FIG. 4, a close-up perspective corner view of the upper vacuum-forming mold system 12 of FIG. 2 is shown. The side curling arm 60 and the belt line curling arm 62 are shown in a curled and tucked state. The side arm 60 is attached to a first billet 150 and is curled via the side connecting rod 152 and the side linkages 154. The side tuck and trim bar 82 is attached to the end 80 of the side arm 60. The heating element 94 is coupled to the side tuck and trim bar 82. The belt line arm 62 is attached to a second billet 154. The belt line tuck and trim bar 84 is attached to the end 80 of the belt line arm 62. The tuck bars 82 and 84 are tucked under side peripheral edges 90.

Referring now to FIG. 5, a front perspective corner view of the upper vacuun-forming mold system 12 of FIG. 2 is shown. A corner billet 160 supports a first corner connecting rod 162 and a second corner connecting rod 164. The first connecting rod 162 is used to move the corner tuck arm 64 to and from the substrate 166. The second connecting rod 164 is used to curl the corner tuck arm 64. The second connecting rod 164 is attached to the corner tuck arm 64 via a link 168, which pivots on a pin 170 that is attached to the billet 160.

Referring now to FIG. 6, a side view of a wrapping, tucking, and trimming mechanism 180 in accordance with an embodiment of the present invention is shown. The trimming mechanism 180 includes a curling arm 182 that has a first portion 184 and a second portion 186, which are separated by an insulator 188. The second portion 186 may be formed of a heat resistant material, such as heat resistant-stainless steel or the like. The insulator 188 may be a phenolic insulator or some other type of insulator known in the art. The portions 184 and 186 and the insulator 188 have a channel 190 therein to allow for placement and attachment to a heating element 192.The heating element 192 is similar to the heating elements 94 described above. The heating element 192 may be located or extended into a machined pocket 193 in the tuck and trim bar 194. A cutting element 196 is attached to or integrally formed as part of the second portion 186. The heating element 192 and the cutting element 196 may be one in the same. The second portion 186 may be formed of similar materials as the tuck and trim bar 194. The cutting element 196 has a height Hi associated therewith that is equal to or greater than the thickness of a cover stock object. This allows for cutting of the cover stock object and/or cutting into an associated substrate(s).

The tuck and trim bars 194 may include one or more raised barbs 198 (only one is shown) of various shapes and sizes that may be machined on either side of the cutting element 196. The raised barbs 198 perform as small mechanical locking features to push or press cover stock material against a substrate during the vacuum-forming process.

Referring now to FIG. 7, a side view of a wrapping and tucking mechanism 200 in accordance with another embodiment of the present invention is shown. The tucking mechanism 200 is similar to the trimming mechanism 180. However, it does not have a cutting element, but rather a smooth tucking surface 202. The tucking mechanism 200 includes a first portion 204 and a second portion 206. The first portion 204 is heated. The first portion 204 is used to apply pressure on and heat the cover stock material 205 over a substrate-cutting element 207. In the embodiment shown, the first portion 204 tucks the cover stock material 205 into a return flange 208 and applies pressure on a return flange-cutting element 210 located on or as an integral part of a center rib 212. This action cuts the cover stock material 205 and bonds the substrate attached peripheral edge 213 of the cover stock material 205 to the return flange 2Q8. The cutting element 210 may not be utilized when using the trimming mechanism 180 of FIG. 6. The cutting element 210 may have an upper cutting edge 214 that is at an angle a that is approximately 60° relative to the center segment 216. The cutting element 210 may have a height Hz that is approximately 2-3 mm. The center rib 216 is located in a ditch 218 of the return flange 208.

Referring now also to FIGS. 8 and 9, perspective views of the belt line return flange 100 in accordance with an embodiment of the present invention are shown. The return flange 100 may be attached to an edge 220 of a substrate 222. The return flange 100 may be sonic welded to the substrate 222 or attached via some other suitable technique. The return flange 100 is in general “L”-shaped and thus has two outer parallel members 224 and 226, one being longer than the other. A center segment 228 extends perpendicular to the parallel members 224 and 226 and is notched. The substrate 222 is attached to the exterior of the notch 228. A cutting element 230 located on or as an integral part of a center rib 232 extends parallel to the parallel members 224 and 226, from the center segment 228, in the ditch 234, and between the notch 228 and the short parallel member 226. Inner protruding cutting elements, such as the cutting element 230 and the like, may be incorporated on any side or corner of the substrate 222 to provide a 360° cutting edge on the substrate 222. Inner protruding cutting elements may be molded on any surface that can be pulled in line of draw or can be post applied for areas that are out of line of draw. The term “line of draw” refers to how the formed parts come out of a mold during ejection. In general, parts that are in line of draw are not moldable. Triangular reinforcements 236 are incorporated on multiple levels of the center segment 228. The short parallel member 226 has ribs 140 with associated notches 142 therebetween. Adhesive may be applied to the ribs 240 for attachment to a cover stock object. As an example, the return flange 100 may be incorporated into a vehicle door and be located at the top of a door panel adjacent a window.

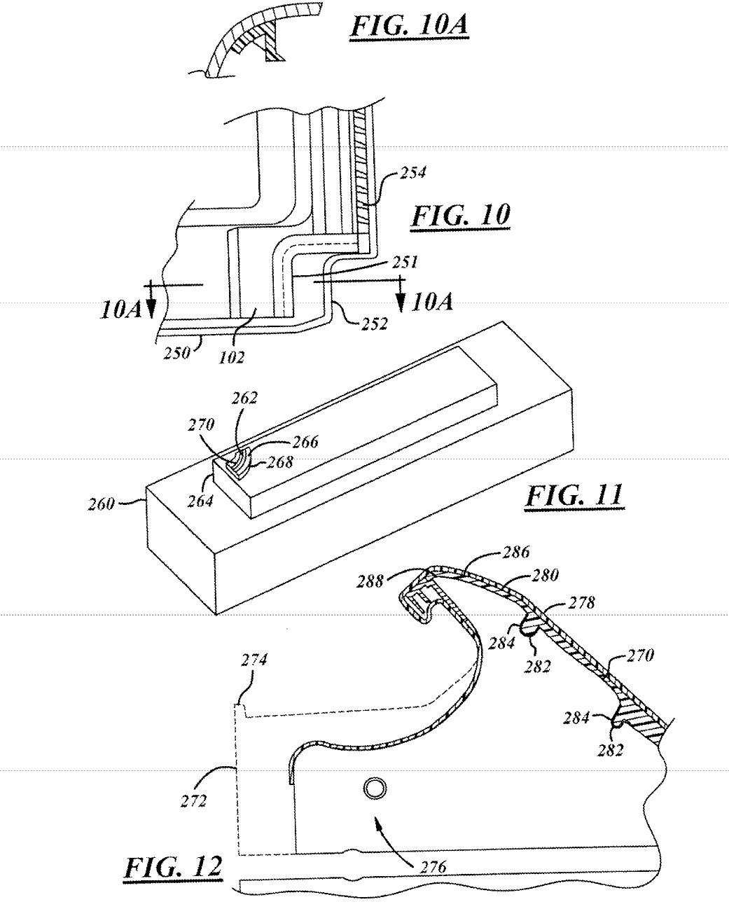

Referring now to FIG. 10, a bottom view of a corner of a substrate 250 incorporating the corner-cutting element 102 is shown in accordance with an embodiment of the present invention. The corner-cutting element 102 has a cutting edge 251 and serves a similar purpose as the cutting element 207. The corner-cutting element 102 is used to cut cover stock material as it is tucked under the corner 252 of the substrate 250 and pressed against the cutting element 102. The corner-cutting element 102 may be sonic welded to the substrate 250 or attached via some other technique known in the art. Notice that the corner-cutting element 102 may abut a belt line return flange 254.

Referring now to FIG. 11, a perspective view of a lower mold 260 of a vacuum-forming system in accordance with another embodiment of the present invention is shown. The lower mold 260 incorporates a mold-cutting element 262. The cutting element 262 is formed as part of the substrate mount 264 and although not shown may be heated, like the cutting elements described above. A protective element 266 is attached over the mold cutting edge 262 and is disposed in a recessed section 268 of the substrate mount 264. The protective element 266 has a slit 270 through which the mold-cutting element 262 may be exposed. The protective element 266 may be formed of urethane, rubber, or some other soft material the may be pushed away to expose the cutting element 262. As a cover stock object is formed over a substrate on the lower mold 260, pressure on the protective element 266 by a nest, such as the nest 36, exposes the mold-cutting element 262 and cuts the cover stock object. Note that in such an embodiment, the substrate does not cover the mold-cutting element 262.

Referring now to FIG. 12, a close-up front sectional view of a substrate mount 270 in accordance with an embodiment of the present invention is shown. In FIG. 12, the shape of a conventional substrate mount 272 is represented by dashed lines. In FIG. 12, the substrate mount 270 is represented by solid lines. Note that the substrate mount 270 does not include a lip, such as the lip 274 of the conventional mold 272, Also, note that the size of the substrate mount 270 in the cal rod area 276 is reduced in both height and width. This allows the cover stock object 278 to better form over the substrate 280 and the substrate mount 270.

The substrate 280 may have tabs 282, which are placed in cutouts 284 on the substrate mount 270, to help hold the substrate 280 in place. The belt line return flange 286 is attached to the substrate and “hooks” over an upper tip 288 of the substrate mount 270. The cover stock object 278 is formed over the substrate 280, the return flange 286, and the substrate mount 270.

Referring now to FIG. 13, a perspective view of a sample trim detail 290 in accordance with an embodiment of the present invention is shown. The trim detail 290 shown is in the form of a door lock knob hole punch, which is attached to the nest 292 of an upper vacuum-forming mold 294. As the upper mold 294 is displaced towards the lower mold 296 the trim detail 290 punches a hole or forms slug 298 in the cover stock object 300. The slug may have tabs (not shown) for removal thereof from the formed component post the vacuum-forming process. The trim detail 290 may be in the form of a wrapping, tucking, and trimming arm., similar to that described above. The trim detail 290 may wrap cover stock material within the hole 302 in the substrate 304.

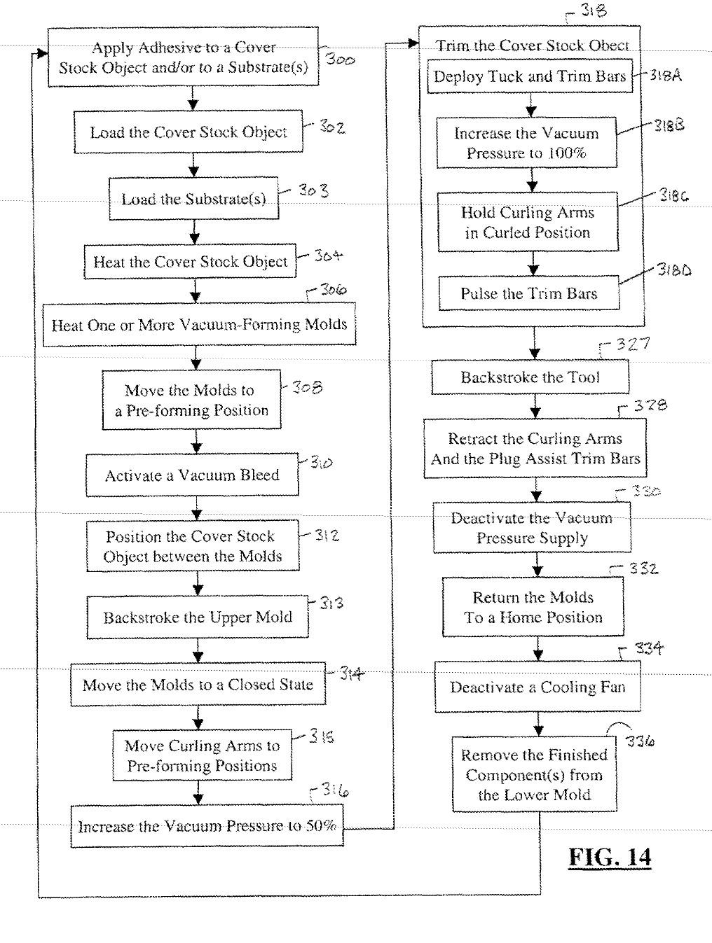

Referring now to FIG. 14, a logic flow diagram illustrating a method of manufacturing a component in accordance with an embodiment of the present invention is shown. Although the following steps are primarily described with respect to the embodiment of FIG. 1, they may be easily modified to apply to other embodiments of the present invention. Also, in the following steps example timing is provided. This timing may be adjusted depending upon the application, the materials utilized, the component being formed, and other relevant factors.

In step 300, adhesive may be applied to the cover stock object and/or the substrate(s) in desired locations. Prior to applying adhesive to the substrates, areas on the substrates may be masked off to prevent exposure to the adhesive. The masking prevents the cover stock object from bonding to the masked areas during the vacuum-forming process. In step 302, a cover stock object is loaded onto the index clamp frame. In step 303, the substrates are loaded onto the lower mold. Steps 302 and 303 may be performed using an automated or manual process and begin and have an associated relative initial set time equal to zero seconds.

In step 304, the cover stock object is heated in an oven. In one embodiment, the cover stock object is heated to approximately 260° F.-360° F. The stated temperature allows for the cover stock material to maintain compliancy for proper tucking. The time involved in transporting the cover stock object to the oven and in heating the cover stock object may be approximately 24 seconds. Thus, step 304 is completed at approximately 24 seconds.

In step 306, the lower mold and /or the upper mold is heated via the mold heating system. In step 308, the upper mold and the lower mold are moved to a pre-forming position. In step 310, at approximately 24 seconds the slow vacuum bleed is activated.

In step 312, the cover stock object is removed from the oven and is positioned between the upper mold and the lower mold in a heated state. In step 313, the upper mold may be moved to a high extended position and then back-stroked or retracted to a second position to start the forming process to aid in the wrapping of the cover stock object. The cover stock object is feed between the upper mold and the lower mold during the retraction motion of the lower mold. At approximately 27.5 seconds from the initial set time steps 312 and 313 are performed.

In step 314, the upper mold and the lower mold are brought together to a closed state. In step 315, the curling arms, such as the end arms, the side arms and/or belt arms, and the corner arms are moved to a pre-forming position adjacent the substrate(s) and external to the molds. In step 316, the vacuum pressure is increased to approximately 50%. Steps 314, 315, and 316 may be performed simultaneously and at approximately 28.5 seconds. The wrapping is aided by the induced vacuum pressure.

In step 318, the cover stock object is trimmed. In step 318A, the tuck and trim bars are deployed. The curling arms are actuated and curled inward to follow and guide the cover stock object to its formed position. The tuck an trim bars attached to the arms are driven by the actuators to chase the cover stock object to contact therewith when the cover stock object stops moving at which the .tuck and trim bars may then further push, stretch and tuck the cover stock object.

In step 3I8B, the vacuum pressure is increased to approximately 100%. At approximately 29.3 seconds from the initial set time step 318B is performed. In step 318C, the curling arms mentioned in step 318A are held in position and the temperature thereof is increased to a cutting temperature. The curling arms may be held for approximately 2 seconds. At approximately 32.3 seconds from the initial set lime step 318C is performed.

In step 318D, the curling arms, the plug assist trim bars, the cutting details, and any other cutting elements may be pulsed for approximately 2 seconds to trim the cover stock object. The upper belt line, the lower flanges, the ends, the holes, the corners, and any other portions of the cover stock object is trimmed. Lock knob holes, power mirror holes, accessory holes, and other holes known in the art may be trimmed out of the cover stock object. At approximately 34.8 seconds from the initial set time step 318D is performed. The combination of the heated cover stock object, the heated cutting elements and/or the second portions of the curling arms, the pressure applied on the cover stock material, and the pulsed curling arms that assures a smooth, accurate, and proper cut of the cover stock object.

In step 327, the molds are backstroked to trim any excess or offal material. The backstroking of the molds while in a closed state trims the offal that is external to the molds,

In step 328, the curling arms and the plug assist trim bars are retracted. At approximately 36.8 seconds from the initial set time step 328 is performed.

In step 330, the vacuum pressure supply is deactivated. In step 332, the upper mold and the lower mold return to a home position. In step 334, a cooling fan may be activated to cool the cover stock object and the substrate to create a finished component. The fan may be activated for approximately 6.2 seconds. Steps 330, 332, and 334 may be performed simultaneously and at approximately 38.8 seconds.

In step 336, the finished component(s) are removed from the lower mold. At approximately 43 seconds from the initial set time step 336 is performed. Steps 300, 302, and 304 may be performed for a subsequent component simultaneously with step 336. Adhesive may be applied to a subsequent cover stock object and to subsequent substrate(s) and the subsequent cover stock object may be loaded and heated as the finished components are being removed from the lower mold.

The present invention provides a vacuum-forming system that reduces and may eliminate secondary edge wrapping and punch trimming on post vacuum- forming parts. The present invention provides wrapping, tucking, and trimming in a single stage and in a 360°format. The present invention provides an improved vacuum-forming process that improves texture retention of a component due to mold heating and improved vacuum-forming of a cover stock material.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A vacuum-forming system for manufacture of a component comprising:
a vacuum-forming mold;
a wrapping arm in operative coupling with said vacuum-forming mold;
a cutting element mechanically coupled to said wrapping arm; and
a controller coupled to and adjusting temperature of said cutting element.

2. A vacuum-forming system as in claim 1 wherein said vacuum-forming mold comprises:
an upper mold;
a lower mold;
at least one vacuum channel in communication with at least one of said upper mold and said lower mold; and
a vacuum source coupled to said at least one vacuum channel and generating a low-pressure environment between a compliant cover stock object and a substrate of-the component to draw said object onto said substrate.

3. A system as in claim 1 wherein said cutting element is selected from at least one of a wrapping arm cutting element, a component-based cutting element, a. substrate cutting element, a tuck bar cutting element, a substrate corner cutting element, and a mold-mounted cutting element.

4. A system as in claim 1 wherein said wrapping arm comprises at least one heating element selected from at least one of a film heater, a cable heater, a flexible heater, and a tubular heater.

5. A system as in claim 1 wherein said cutting element bonds a compliant cover stock object to a substrate of the component.

6. A system as in claim 1 wherein at least a portion of said vacuum-forming mold is configured for temperature adjustment thereof.

7. A system as in claim 1 further comprising at least one heating element thermally coupled to said vacuum-forming mold.

8. A system as in claim 7 further comprising a temperature regulator coupled to and used to regulate temperature of said at least one heating element.

9. A system as in claim 1 further comprising at least one actuator coupled to said wrapping arm, said controller coupled to and controlling operation of said at least one actuator.

10. A system as in claim 9 where in said at least one actuator is selected from a pneumatic actuator, a hydraulic actuator, and a pneudraulic actuator.

11. A system as in claim 9 further comprising a sensor coupled to said at least one actuator and said controller, said controller adjusting position of said wrapping arm in response to a signal generated by said sensor.

12. A vacuum-forming system for manufacture of a component comprising:
a vacuum-forming mold;
a wrapping arm in operative coupling with said vacuum-forming mold;
a cutting element, selected from at least one of a component-based cutting element and a mold-mounted cutting element, mechanically coupled to said wrapping arm; and
a controller coupled to and controlling operation of said wrapping arm to wrap a compliant cover stock object on a substrate and to simultaneously trim said object via said cutting element.

13. A system as in claim 12 wherein said component-based cutting element comprises at least one cutting edge selected from a tuck bar cutting edge, a substrate cutting edge, and a corner cutting edge.

14. A system as in claim 12 further comprising a pressure applicator coupled to said wrapping arm and used to apply pressure on said object over said cutting element.

15. A system as in claim 12 wherein said mold-mounted cutting element comprises:
a cutting element; and
a protective cover displaceable to reveal said cutting element.

16. A system as in claim 12 wherein at least a portion of said vacuum-forming mold is configured for temperature adjustment thereof.

17. A vacuum-forming system for manufacture of a component comprising:
a vacuum-forming mold configured for vacuum-forming a compliant cover stock object onto a substrate of the component;
a plurality of wrapping arms in operative coupling with said vacuum-forming mold and wrapping a plurality of peripheral edges of said object on a substrate of the component simultaneously with said vacuum-forming; and
a controller coupled to and controlling wrapping operation of said plurality of wrapping arms.

18. A system as in claim 17 wherein said plurality of wrapping arms comprises a plurality of arms selected from an edge wrapping arm, a tuck bar wrapping arm, a corner wrapping arm, and a side wrapping arm.

19. A system as in claim 17 wherein said plurality of wrapping arms comprises a plurality of cutting elements, said controller maintaining temperature of said cutting elements at a predetermined uniform temperature.

20. A system as in claim 17 wherein at least a portion of said vacuum-forming mold is configured for temperature adjustment thereof.
